(19) United States
(12) Patent Application Publication
(10) Pub. No.: US 2025/0123797 A1
(43) Pub. Date: Apr. 17, 2025

(54) VOICE CONTROL APPARATUS

(71) Applicant: TOYOTA JIDOSHA KABUSHIKI KAISHA, Toyota-shi (JP)

(72) Inventors: Yu NAGATA, Tokyo-to (JP); Ryota YANAGISAWA, Tokyo-to (JP); Akira MIYAMOTO, Nisshin-shi (JP); Eiichi MAEDA, Asaka-shi (JP); Haruto TOYAMA, Nagoya-shi (JP); Kotaro HIROSE, Nisshin-shi (JP); Yasuhiro KOBATAKE, Nagoya-shi (JP)

(73) Assignee: TOYOTA JIDOSHA KABUSHIKI KAISHA, Toyota-shi (JP)

(21) Appl. No.: 18/888,154

(22) Filed: Sep. 18, 2024

(30) Foreign Application Priority Data
Oct. 13, 2023 (JP) 2023-177807

(51) Int. Cl. G06F 3/16; B60W 50/00; B60W 50/14

(52) U.S. Cl. CPC G06F 3/165; B60W 50/14; B60W 2050/0083; B60W 2520/10; B60W 2555/20; B60W 2556/45

(57) ABSTRACT

A voice control apparatus includes a controller configured to detect a speed of a vehicle, and set a frequency of voice output for an occupant of the vehicle higher as the detected speed increases.

### CROSS-REFERENCE TO RELATED APPLICATION

This application claims priority to Japanese Patent Application No. 2023-177807, filed on Oct. 13, 2023, the entire contents of which are incorporated herein by reference.

### TECHNICAL FIELD

The present disclosure relates to a voice control apparatus.

### BACKGROUND

Patent Literature (PTL) 1 discloses a voice recognition apparatus that performs voice recognition after pre-processing to remove noises such as a travel sound of a vehicle.

### CITATION LIST

### Patent Literature

PTL 1: JP 2010-271452 A

### SUMMARY

When outputting voice in a vehicle, it may be difficult to hear the output voice due to noise from outside the vehicle if the frequency of the voice output is low.

It would be helpful to perform voice output that takes into account the speed of the vehicle and make it easier to hear the output voice.

A voice control apparatus according to the present disclosure includes a controller configured to:
detect a speed of a vehicle; and
set a frequency of voice output for an occupant of the vehicle higher as the detected speed increases.

According to the present disclosure, the frequency of voice output is set higher as the speed of a vehicle increases, thereby making it easier for an occupant to hear the output voice.

### BRIEF DESCRIPTION OF THE DRAWINGS

In the accompanying drawings:

FIG. 1 is a diagram illustrating a configuration of a system according to an embodiment of the present disclosure;

FIG. 2 is a block diagram illustrating a configuration of a voice control apparatus according to the embodiment of the present disclosure;

FIG. 3 is a flowchart illustrating operations of the voice control apparatus according to the embodiment of the present disclosure;

FIG. 4 is a flowchart illustrating additional operations of the voice control apparatus according to the embodiment of the present disclosure; and

FIG. 5 is a flowchart illustrating other additional operations of the voice control apparatus according to the embodiment of the present disclosure.

### DETAILED DESCRIPTION

An embodiment of the present disclosure will be described below, with reference to the drawings.

In the drawings, the same or corresponding portions are denoted by the same reference numerals. In the descriptions of the present embodiment, detailed descriptions of the same or corresponding portions are omitted or simplified, as appropriate.

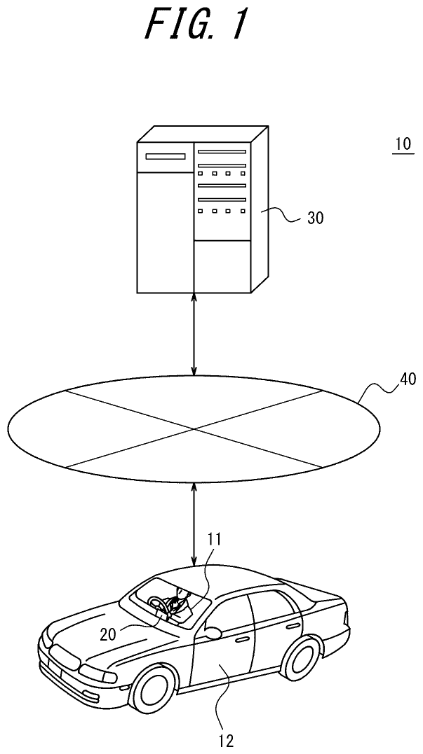

A configuration of a system 10 according to the present embodiment will be described with reference to FIG. 1.

The system 10 according to the present embodiment includes a voice control apparatus 20 and a server apparatus 30. The voice control apparatus 20 can communicate with the server apparatus 30 via a network 40.

The voice control apparatus 20 is a computer with voice control capability installed in the vehicle 12. The voice control apparatus 20 is used by a user 11. The user 11 is an occupant of the vehicle 12.

The server apparatus 30 is a computer that belongs to a cloud computing system or other computing system installed in a facility such as a data center. The server apparatus 30 is operated by a service provider, such as a web service provider.

The vehicle 12 is, for example, any type of automobile such as a gasoline vehicle, a diesel vehicle, a hydrogen vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The vehicle 12, which is driven by a driver, may be automated at certain levels. The automation level is, for example, any one of Level 1 to Level 4 according to the level classification defined by SAE. The name “SAE” is an abbreviation of Society of Automotive Engineers. The vehicle 12 may be a MaaS-dedicated vehicle. The term “MaaS” is an abbreviation of Mobility as a Service.

The network 40 includes the Internet, at least one WAN, at least one MAN, or any combination thereof. The term “WAN” is an abbreviation of wide area network. The term “MAN” is an abbreviation of metropolitan area network. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIG. 1.

The voice control apparatus 20 detects the speed of the vehicle 12, and sets the frequency of voice output for an occupant of the vehicle 12 higher as the detected speed increases.

According to the present embodiment, the speed of the vehicle 12 can be taken into account to provide voice output. Thus, the output voice can be easily heard.

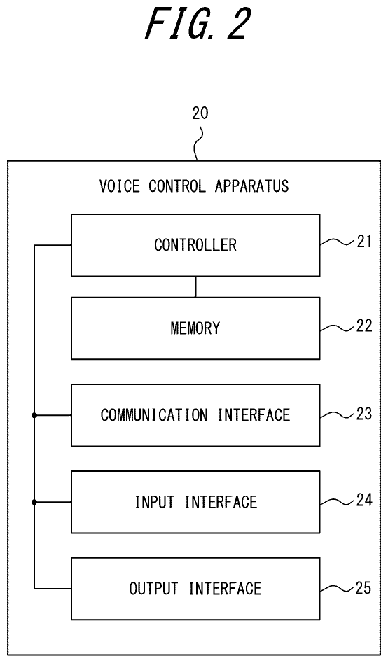

A configuration of the voice control apparatus 20 according to the present embodiment will be described with reference to FIG. 2.

The voice control apparatus 20 includes a controller 21, a memory 22, a communication interface 23, an input interface 24, and an output interface 25.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the voice control apparatus 20 while controlling components of the voice control apparatus 20.

The memory 22 includes at least one semiconductor memory, at least one magnetic memory, at least one optical memory, or any combination thereof. The semiconductor memory is, for example, RAM, ROM, or flash memory. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The flash memory is, for example, SSD. The term “SSD” is an abbreviation of solid-state drive. The magnetic memory is, for example, HDD. The term “HDD” is an abbreviation of hard disk drive. The memory 22 functions as, for example, a main memory, an auxiliary memory, or a cache memory. The memory 22 stores information to be used for the operations of the voice control apparatus 20 and information obtained by the operations of the voice control apparatus 20.

The communication interface 23 includes at least one communication module. The communication module is, for example, a module compatible with a mobile communication standard such as LTE, the 4G standard, or the 5G standard, a wireless LAN communication standard such as IEEE802.11. The term “LTE” is an abbreviation of Long Term Evolution. The term “4G” is an abbreviation of 4th generation. The term “5G” is an abbreviation of 5th generation. The name “IEEE” is an abbreviation of Institute of Electrical and Electronics Engineers. The communication interface 23 communicates with the server apparatus 30. The communication interface 23 receives information to be used for the operations of the voice control apparatus 20 and transmits information obtained by the operations of the voice control apparatus 20.

The input interface 24 includes at least one input device. The input device is, for example, a physical key, a capacitive key, a pointing device, a touch screen integrally provided with a display, a visible light camera, a LiDAR sensor, or a microphone. The term “LiDAR” is an abbreviation of light detection and ranging. The input interface 24 accepts an operation for inputting information to be used for the operations of the voice control apparatus 20. Instead of being included in the voice control apparatus 20, the input interface 24 may be connected to the voice control apparatus 20 as an external input device. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one output device. The output device is, for example, a display or a speaker. The display is, for example, an LCD or an organic EL display. The term “LCD” is an abbreviation of liquid crystal display. The term “EL” is an abbreviation of electro luminescent. The output interface 25 outputs information obtained by the operations of the voice control apparatus 20. The output interface 25, instead of being included in the voice control apparatus 20, may be connected to the voice control apparatus 20 as an external output device such as a display audio. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used.

The functions of the voice control apparatus 20 are realized by execution of a program according to the present embodiment by a processor serving as the controller 21. That is, the functions of the voice control apparatus 20 are realized by software. The program causes a computer to execute the operations of the voice control apparatus 20, thereby causing the computer to function as the voice control apparatus 20. That is, the computer executes the operations of the voice control apparatus 20 in accordance with the program to thereby function as the voice control apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the voice control apparatus 20 may be realized by a programmable circuit or a dedicated circuit serving as the controller 21. That is, some or all of the functions of the voice control apparatus 20 may be realized by hardware.

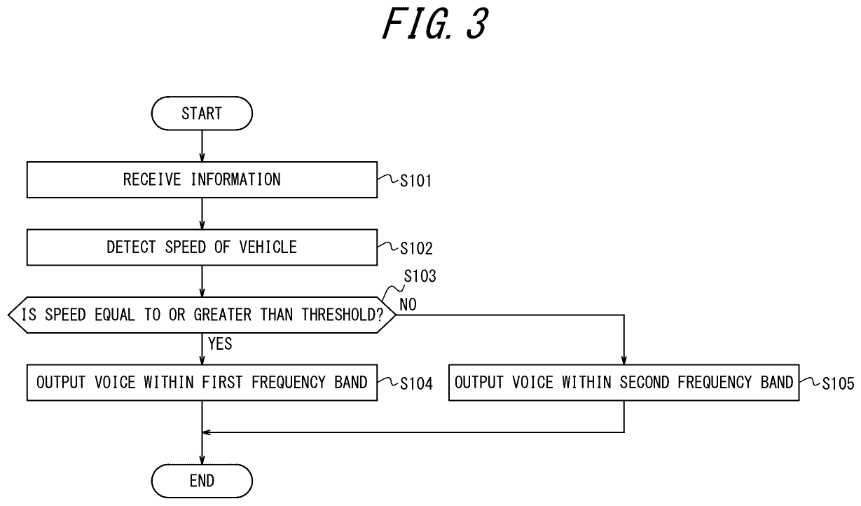

Operations of the voice control apparatus 20 according to the present embodiment will be described with reference to FIG. 3. The operations described below correspond to a control method according to the present embodiment. In other words, the control method according to the present embodiment includes steps S101 through S105 illustrated in FIG. 3.

In S101, the controller 21 receives information for the user 11 from outside the vehicle 12 via the communication interface 23. Specifically, the controller 21 receives information addressed to the user 11 from the server apparatus 30 via the communication interface 23. The server apparatus 30 provides, for example, a mail server or messaging service. Thus, information addressed to the user 11 is, for example, an email or message addressed to the user 11 sent electronically. The controller 21 can convey information to the user 11 by outputting a voice reading out this mail or message from the speaker as the output interface 25 in S104 or S105 described below. The received information addressed to the user 11 is stored in the memory 22.

In S102, the controller 21 detects the speed of the vehicle 12. Specifically, the controller 21 detects the speed by receiving information on the speed of the vehicle 12 via the communication interface 23 from a speedometer mounted on the vehicle 12. The controller 21 may detect the speed by receiving from the server apparatus 30 the speed information transmitted by the vehicle 12 to the server apparatus 30. The detected speed is stored in the memory 22.

In S103, the controller 21 determines whether the speed of the vehicle 12 detected in S102 exceeds the threshold. If the speed exceeds the threshold (S103—YES), the process proceeds to S104. If the speed is equal to or less than the threshold (S103—NO), the process proceeds to S105. For example, if the speed detected in S102 is 80 km/h and the threshold is 60 km/h, the process proceeds to S104 because the speed exceeds the threshold.

Although only one threshold is set in the present embodiment, more than one threshold may be set. The threshold is stored in the memory 22 in advance, or the controller 21 may receive them from the server apparatus 30.

In S104, the controller 21 outputs the information received in S101 to voice within the first frequency band. The first frequency band is, for example, between 250 Hz and 300 Hz, the fundamental frequency of the Japanese female voice. For example, the controller 21 reads out the email or message from a speaker as the output interface 25 within a frequency band of between 250 Hz and 300 Hz. Noise from outside the vehicle 12 has many low-pitched components, so that as the speed of the vehicle 12 increases, the noise, namely, the low-pitched components become larger. Therefore, by outputting voice within the female frequency band, i.e., the higher frequency band, the easier it is for the user 11 to hear the mail or message that is read out.

In S105, the controller 21 outputs the information received in S101 to voice within the second frequency band, which is lower than the first frequency band. The second frequency band is, for example, between 150 Hz and 200 Hz, the fundamental frequency of the Japanese male voice. For example, the controller 21 reads out the e-mail or message from a speaker as the output interface 25 within a frequency band between 150 Hz and 200 Hz.

The first frequency band is not limited to a range between 250 Hz and 300 Hz, and the second frequency band is not limited to a range between 150 Hz and 200 Hz; both can be set to any frequency band where the first frequency band is higher than the second frequency band. In the present embodiment, two frequency bands are set corresponding to one threshold, but three or more frequency bands may be set corresponding to two or more thresholds as described above. For example, the threshold may be set at 80 km/h and 60 km/h, and voice output may be at 400 Hz when the detected speed is greater than 80 km/h, 300 Hz when the detected speed is greater than 60 km/h and equal to or less than 80 km/h, and 150 Hz when the detected speed is equal to or less than 60 km/h.

After S104 or S105, the flow illustrated in FIG. 3 ends.

As mentioned above, in the present embodiment, the controller 21 detects the speed of the vehicle 12. The controller 21 sets the frequency of the voice output for the user 11 higher as the detected speed increases. Thus, it is easier for the user 11 to hear the output voice.

In the present embodiment, the controller 21 sets the frequency of the voice output within the female frequency band when the detected speed exceeds a threshold previously determined, and sets the frequency of the voice output within the male frequency band when the detected speed is equal to or less than the threshold. According to the present embodiment, switching the output voice between a male voice and a female voice can further suppress the discomfort of frequent or linear changes in the frequency of the output voice, while also suppressing the difficulty of hearing the voice.

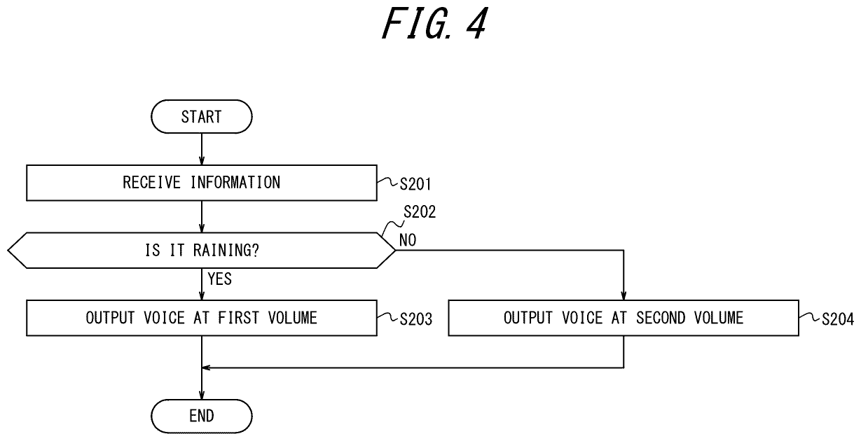

Additional operations of the voice control apparatus 20 according to the present embodiment will be described with reference to FIG. 4. However, step S201 is the same as step S101 illustrated in FIG. 3, and thus a description thereof is omitted.

In S202, the controller 21 determines whether it is raining outside the vehicle 12. Specifically, the controller 21 receives captured images of the outside of the vehicle 12 from a camera mounted on the vehicle 12 via the communication interface 23 and analyzes the received captured images to determine whether it is raining or not. Alternatively, the controller 21 may determine whether it is raining by receiving information from the network in the vehicle 12 via the communication interface 23 on whether the wipers of the vehicle 12 are moving. Alternatively, the controller 21 may determine whether it is raining by receiving information from the server apparatus 30 via the communication interface 23 on whether it is raining in the area where the vehicle 12 is traveling. If it is determined that it is raining (S202—YES), i.e., rain is detected outside the vehicle 12, the process proceeds to S203. If it is determined that it is not raining (S202—NO), the process proceeds to S204.

By the step of S202, the controller 21 detects that noise is being generated outside the vehicle 12 that makes it difficult to hear voice inside the vehicle 12. In the present embodiment, only whether it is raining or not is determined, but the volume of the voice output may be varied depending on the amount of rain that is falling. For example, if the amount of rain falling outside the vehicle 12 is greater than the standard amount, the controller 21 may output voice at a louder volume than if the amount of rain falling outside the vehicle 12 is less than the standard amount.

In S203, the controller 21 outputs the information received in S201 to voice at the first volume. The first volume is, for example, volume “15” when the maximum volume is volume “20”. For example, the controller 21 reads out the e-mail or message from the speaker as the output interface 25 at volume “15”. If it is raining outside the vehicle 12, the noise from the outside vehicle 12 will be louder. Therefore, the user 11 can easily hear the mail or message read out by increasing the volume of the voice output.

In S204, the controller 21 outputs the information received in S201 to voice at a second volume lower than the first volume. The second volume is, for example, volume “10” when the maximum volume is volume “20”. For example, the controller 21 reads out the e-mail or message from the speaker as output interface 25 at volume “10”.

After S203 or S204, the flow illustrated in FIG. 4 ends.

As mentioned above, the controller 21 increases the volume of the voice output when it detects that it is raining outside the vehicle 12. Thus, it is possible to make the output voice even easier for the user 11 to hear.

The operations illustrated in FIG. 3 and FIG. 4 may be performed at the same time or at different times. For example, the controller 21 may determine whether it is raining in S202 after determining whether the speed of the vehicle 12 exceeds the threshold in S103. If S103—YES and S202—YES, the controller 21 may output voice at a frequency of 300 Hz and volume “15”.

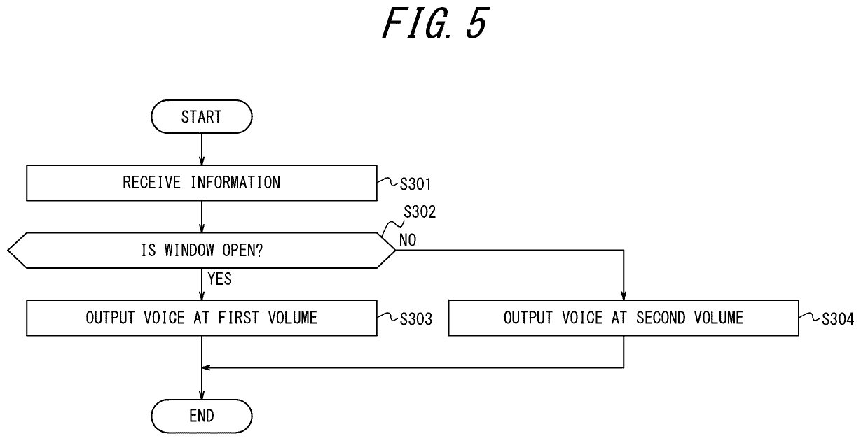

Other additional operations of the voice control apparatus 20 according to the present embodiment will be described with reference to FIG. 5. However, steps S301, S303, and S304 are the same as steps S201, S203, and S204 illustrated in FIG. 4, respectively, and thus a description thereof is omitted.

In S302, the controller 21 determines whether a window of the vehicle 12 is open. Specifically, the controller 21 determines whether the window is open or not by receiving information from the network in the vehicle 12 via the communication interface 23 whether the window of the vehicle 12 is open or not. If it is determined that the window is open (S302—YES), i.e., the window of the vehicle 12 is detected to be open, the process proceeds to S303. If the window is determined to be closed (S302—NO), the process proceeds to S304.

By the step of S302, the controller 21 detects that noise that makes it difficult to hear voice is easily transmitted inside the vehicle 12. In the present embodiment, only whether the window is open or not is determined, but the volume of the voice output may be varied depending on the degree to which the window is open. For example, if the windows of the vehicle 12 are fully open, the controller 21 may output voice at a louder volume than if the windows of the vehicle 12 are partially open.

After S303 or S304, the flow illustrated in FIG. 5 ends.

As mentioned above, the controller 21 increases the volume of the voice output when it detects that the windows of the vehicle 12 are open. Thus, it is possible to make the output voice even easier for the user 11 to hear.

The operations illustrated in FIG. 3 and FIG. 5 may be performed at the same time or at different times. For example, the controller 21 may determine whether the window is open in S302 after determining whether the speed of the vehicle 12 exceeds the threshold in S103. If S103—YES and S302—YES, the controller 21 may output voice at a frequency of 300 Hz and volume “15”.

The operations illustrated in FIG. 4 and FIG. 5 may be combined. For example, it may determine if it is raining at S202 and further determine if the window is open at S302. If S202—YES and S302—YES, the controller 21 may output voice at the first volume. If S202—YES and S302—NO, the controller 21 may output voice at a second volume that is lower than the first volume. If S202—NO and S302—YES, the controller 21 may output voice at a third volume that is lower than the second volume. In the case of S202—NO and S302—NO, the controller 21 may output voice at a fourth volume that is lower than the third volume. Instead of the volume decreasing in the order of first volume, second volume, third volume, and fourth volume, the volume may decrease in the order of first volume, third volume, second volume, and fourth volume.

The present disclosure is not limited to the embodiment described above. For example, two or more blocks described in the block diagrams may be integrated, or a block may be divided. Instead of executing two or more steps described in the flowcharts in chronological order in accordance with the description, the steps may be executed in parallel or in a different order according to the processing capability of the apparatus that executes each step, or as required. Other modifications can be made without departing from the spirit of the present disclosure.

1. A voice control apparatus comprising a controller configured to:
detect a speed of a vehicle; and
set a frequency of voice output for an occupant of the vehicle higher as the detected speed increases.

2. The voice control apparatus according to claim 1, wherein the controller is configured to:
set the frequency of the voice output within a female frequency band in a case in which the speed exceeds a threshold previously determined; and
set the frequency of the voice output within a male frequency band in a case in which the speed is equal to or less than the threshold.

3. The voice control apparatus according to claim 1, further comprising a communication interface configured to receive information for the occupant of the vehicle from outside the vehicle,
wherein the voice output includes voice output that reads out the information received by the communication interface.

4. The voice control apparatus according to claim 1, wherein the controller is configured to, upon detecting that it is raining outside the vehicle, increase volume of the voice output.

5. The voice control apparatus according to claim 1, wherein the controller is configured to, upon detecting that a window of the vehicle is open, increase volume of the voice output.
